(19) United States
(12) Patent Application Publication
(10) Pub. No.: US 2026/0242917 A1
(43) Pub. Date: Aug. 20, 2026

(54) PULSE MAGNETIC FIELD TREATMENT METHOD FOR ELIMINATING RESIDUAL STRESS IN COPPER ALLOY FOILS

(71) Applicant: TAIYUAN UNIVERSITY OF TECHNOLOGY, Taiyuan (CN)

(72) Inventors: Junwei QIAO, Taiyuan (CN); Xi JIN, Taiyuan (CN); Chong WANG, Taiyuan (CN); Tian WANG, Taiyuan (CN); Min ZHANG, Taiyuan (CN); Huijun YANG, Taiyuan (CN)

(21) Appl. No.: 19/078,291

(22) Filed: Mar. 13, 2025

(30) Foreign Application Priority Data
Feb. 17, 2025 (CN) 202510172936.0

(51) Int. Cl. C22F 3/02; B22D 21/02; B22D 27/02; C22C 9/06; C22F 1/08; C23G 1/10

(52) U.S. Cl. CPC C22F 3/02; B22D 21/025; B22D 27/02; C22C 9/06; C22F 1/08; C23G 1/103

(57) ABSTRACT

A pulse magnetic field treatment method for eliminating residual stress in copper alloy foils, including steps of alloy casting, solution treatment, hot rolling, hot rolling and tension annealing. All the steps are performed under the pulse magnetic field. This method can significantly reduce the residual stress in the alloy and even achieve the effect of elimination, and to some extent improve the strength and conductivity of the alloy strip. It is suitable for the final etching process of the alloy strip to meet the performance requirements of copper alloy foils for lead frames.

### CROSS REFERENCE TO RELATED APPLICATIONS

This application claims foreign priority of Chinese Patent Application No. 202510172936.0, filed on Feb. 17, 2025 in the China National Intellectual Property Administration, the disclosures of all of which are hereby incorporated by reference.

### TECHNICAL FIELD

The present disclosure relates to the technical field of alloy foils treatment technology, in particular to a pulse magnetic field treatment method for eliminating residual stress in copper alloy foils.

### BACKGROUND

The integrated circuit industry is the focus of global technological competition both now and in the future. Currently, copper alloy leadframes, as the chip carriers for integrated circuits, serve as the channel for chip information to communicate with the outside world and are crucial basic materials in the semiconductor industry. The copper alloy foils used in leadframes are mainly produced through chemical etching. Although etching, as a stress-free processing method, can achieve the production of high-density, multi-pin leadframes, this method imposes stricter requirements on the internal stress, warping, surface quality, and etching performance of the copper alloy foils. During etching, the rolled copper alloy foils may warp due to uneven stress release, which severely impacts the subsequent use of the product. Therefore, with the continuous improvement in product performance requirements, how to effectively reduce residual stress while balancing the strength and conductivity of the copper alloy foils, and improve its etching performance, has become an important research topic.

It is well known that almost all metal materials undergo some degree of change in plasticity when exposed to a magnetic field, which can improve their properties, such as enhanced wear resistance, extended fatigue life, and altered electrical resistivity. pulse magnetic fields can effectively reduce residual stress and improve material properties through various mechanisms, such as influencing dislocation movement, magnetostrictive effects, selective grain deformation, dislocation multiplication, stress and homogenization of residual relaxation, stress. Compared to conventional heat treatment methods, magnetization treatment is simple to operate, requires low investment, has quick results, and is pollution-free. Research has shown that magnetic annealing has a significant impact on the texture and microstructure evolution of non-ferrous metal alloys. The effects and regulation of magnetic field annealing on the microstructure and texture of metal materials remain a hot topic for many scholars. The influence of magnetic field annealing on texture, microstructure, and magnetism is still a major research direction for scientists, and exploring its underlying mechanisms remains an ongoing challenge.

### SUMMARY

The present disclosure provides a pulse magnetic field treatment method for eliminating residual stress in copper alloy foils, to solve the technical problem of effectively reducing residual stress and improving etching performance while enhancing strength and conductivity.

To realize the above objective, the present disclosure provides a pulse magnetic field treatment method for eliminating residual stress in copper alloy foils, including:
S1, alloy casting: under a pulse magnetic field, melting copper alloys at a temperature of 1000° C. to 1300° C. to obtain alloy melt, and injecting the alloy melt into a mold for cooling and casting to obtain a cast ingot;
S2, solution treatment: under the pulse magnetic field, heating the cast ingot to a holding temperature of 800° C. to 1350° C., and holding for 0.5 h to 24 h to dissolve a second phase in the copper alloys completely or maximally into a solid solution matrix, to obtain a solution-treated cast ingot;
S3, hot rolling: under the pulse magnetic field, performing a hot rolling process on the solution-treated cast ingot, to obtain a copper alloy slab;
S4, cold rolling: under the pulse magnetic field, carrying out N passes of cold rolling process on the copper alloy slab, where N represents a positive integer, until a desired thickness is achieved, obtaining copper alloy foils;
S5, magnetic field treatment and tension annealing: under the pulse magnetic field, heating and annealing the copper alloy foils at an annealing temperature of 100° C. to 400° C. for a holding time of 30 s to 12 h, to obtain copper alloy foil samples with eliminated residual stress.

Furthermore, specific parameters of the pulse magnetic field in S1 to S5 are as follows: a current of 20 A to 100000 A, a frequency of 20 Hz to 100 Hz, a duty cycle of 20% to 100%.

Furthermore, during the solution treatment in S2, an inert gas is continuously introduced to prevent oxidation of the cast ingot.

Furthermore, a time interval for the hot rolling process of the solution-treated ingot does not exceed 30 s.

Furthermore, after S2, performing a acid pickling process to the solution-treated cast ingot; and
after S3, performing the acid pickling process to the copper alloy slab; and
after S4, performing the acid pickling process to the copper alloy foils.

Furthermore, performing an intermediate annealing treatment during cold rolling passes of the cold rolling process in S4, to reduce the alloy hardness and facilitates further cold rolling of the copper alloy slab; wherein a intermediate annealing temperature is 100° C. to 800° C., with a holding time of 10 min to 12 h.

Furthermore, a cold rolling pass of the intermediate annealing treatment is 10 to 30 through out the cold rolling process in S4.

Furthermore, in S5, the copper alloy foils are heated and annealed under the pulse magnetic field, a combined effect of a magnetic field, a thermal field, and a force reduces the residual stress within the copper alloy foils and improves properties of the copper alloy foils.

Furthermore, a direction of the pulse magnetic field should be controlled.

Furthermore, the copper alloys are Cu—Fe alloys, Cu—Cr alloys, or Cu—Ni alloys.

Compared with the prior arts, the present application has the following advantages:

The application introduces pulsed magnetic field into the production process of copper alloys across the entire industrial chain for the first time. Through the coupling effects of magnetic force, mechanical force, and thermal field, it reduces the residual stress within the alloy while improving properties such as strength and electrical conductivity. This is beneficial for the final etching process in lead frame molding, meeting the performance requirements for copper alloy foils used in lead frames.

The pulsed magnetic field technology introduced into the copper alloy industrial chain production process is simple in equipment, easy to operate, economically efficient, environmentally friendly, and highly versatile. It is not only suitable for performance improvement as a standalone process but can also be combined with thermal fields to further reduce residual stress without affecting the performance of the original product. Additionally, there are no special requirements for the alloy workpieces during the treatment process. This technology is suitable for the rapid processing of alloy workpieces of various sizes and complex structures, significantly reducing production costs, and is expected to be applied to the treatment of various alloy components in other categories.

### BRIEF DESCRIPTION OF THE DRAWINGS

In order to better explain the technical solutions in the embodiments of this application, a brief introduction to the drawings that need to be used in the embodiment description will be given below. It is evident that the drawings described below are merely some embodiments of this application. For those skilled in the art, other drawings can be derived from these without the need for creative labor.

FIG. 1 is a flowchart of a pulse magnetic field treatment method for eliminating residual stress in copper alloy foils according to an embodiment of the present application;

FIG. 2 is a diagram of nanoindentation loading curves of the pulse magnetic field treatment method for eliminating residual stress in the copper alloy foils according to an embodiment of the present application;

FIG. 3 shows scanning electron microscopy images of microstructures of copper alloy foils (a) and copper alloy foil samples (b) according to an embodiment of the present application.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

In order to give a deeper explanation of the present application, we will provide a comprehensive and detailed description. However, the application has multiple embodiments and is not limited to the specific examples listed herein. The presentation of these examples aims to enhance the overall understanding of the disclosed content of the application.

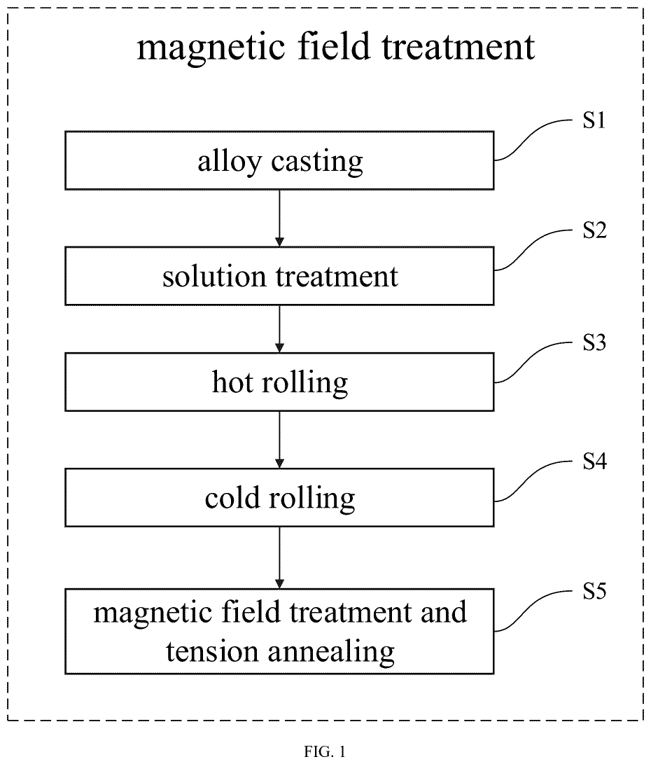

The material of a cast ingot in the following embodiments is copper alloys for lead frames, specifically a Cu-0.23Fe-0.06P alloy. To illustrate the effect of the magnetic field and the coupling of the magnetic field and thermal field, the flowchart of the pulse magnetic field treatment method for eliminating residual stress in copper alloy foils is shown in FIG. 1.

The pulse magnetic field control conditions in this embodiment include voltage, current, frequency, and duty cycle. During the pulse magnetic field treatment, the direction of the magnetic field should be controlled (unless otherwise specified, the rolling direction is parallel to the magnetic field direction).

### Embodiment 1

Parameters of the pulse magnetic field in this embodiment are as follows: voltage of 100V, peak current of 100 A, frequency of 20 Hz, and duty cycle of 20%.

A pulse magnetic field treatment method for eliminating residual stress in copper alloy foils is shown in FIG. 1, including the following steps:
S1, alloy casting: under the pulse magnetic field, melting the copper alloys at a temperature of 1200° C., performing a deoxidization process, to obtain alloy melt, and then injecting the alloy melt into a mold for cooling and casting to obtain an cast ingot.
S2, solution treatment: under the pulse magnetic field, heating the cast ingot at a temperature of 1000° C. and holding for 12 hours to dissolve a second phase in the copper alloy into the solid solution matrix as completely as possible, to obtain a solution-treated cast ingot. During the solution treatment, nitrogen is continuously passed into the heating furnace.

Performing a acid pickling process to the solution-treated cast ingot.
S3, hot rolling: under the pulse magnetic field, performing a hot rolling process on the solution-treated cast ingot with a 20-second time interval, to obtain a copper alloy slab with a thickness of 16.5 mm.

Performing a acid pickling process to the copper alloy slab.
S4, cold rolling: under the pulse magnetic field, carrying out 10 passes of cold rolling process on the copper alloy slab. Intermediate annealing treatment is applied between the cold rolling passes, with a temperature of 500° C. and a holding time of 2 hours, until the thickness is reduced to 0.203 mm, obtaining copper alloy foils.

Performing a acid pickling process to the copper alloy foils.
S5, magnetic field treatment and tension annealing: under the pulse magnetic field, heating and annealing the copper alloy foils at an annealing temperature of 200° C. for a holding time of 3 min. Combining heat treatment and magnetic field treatment, followed by water cooling, the residual stress value is measured to be 9.8 MPa, which has transitioned from the initial compressive stress to a tensile stress state. The residual stress of the copper alloy foil samples have decreased by 100%.

### Embodiment 2

The differences between embodiment 2 and embodiment 1 is that:
S4, cold rolling: under the pulse magnetic field, carrying out 30 passes of cold rolling process on the copper alloy slab. Intermediate annealing treatment is applied between the cold rolling passes, with a temperature of 100° C. and a holding time of 12 hours, until the thickness is reduced to 0.203 mm, obtaining copper alloy foils.

Performing a acid pickling process to the copper alloy foils.
S5, magnetic field treatment and tension annealing: under the pulse magnetic field, heating and annealing the copper alloy foils at an annealing temperature of 100° C. for a holding time of 12 h. Combining heat treatment and magnetic field treatment, followed by water cooling, the residual stress value is measured to be −50 MPa, which has transitioned from the initial compressive stress to a tensile stress state. The residual stress of the copper alloy foil samples have decreased by 65%.

### Embodiment 3

The differences between embodiment 3 and embodiment 1 is that:

Parameters of the pulse magnetic field in this embodiment are as follows: peak current of 100000 A, frequency of 100 Hz, and duty cycle of 100%.
S4, cold rolling: under the pulse magnetic field, carrying out 30 passes of cold rolling process on the copper alloy slab. Intermediate annealing treatment is applied between the cold rolling passes, with a temperature of 800° C. and a holding time of 10 min, until the thickness is reduced to 0.203 mm, obtaining copper alloy foils.

Performing a acid pickling process to the copper alloy foils.
S5, tension annealing and magnetic field treatment: under the pulse magnetic field, heating and annealing the copper alloy foils at an annealing temperature of 400° C. for a holding time of 30 s. Combining heat treatment and magnetic field treatment, followed by water cooling, the residual stress value is measured to be 10 MPa, which has transitioned from the initial compressive stress to a tensile stress state. The residual stress of the copper alloy foil samples have decreased by 100%.

### Embodiment 4

Parameters of the pulse magnetic field in this embodiment are as follows: peak current of 100 A, frequency of 20 Hz, and duty cycle of 20%.

A pulse magnetic field treatment method for eliminating residual stress in copper alloy thin strips is shown in FIG. 1, including the following steps:
S1, alloy casting: under the pulse magnetic field, melting the copper alloys at a temperature of 1300° C., performing a deoxidization process, to obtain alloy melt, and then injecting the alloy melt into a mold for cooling and casting to obtain an cast ingot.
S2, solution treatment: under the pulse magnetic field, heating the cast ingot at a temperature of 1350° C. and holding for 0.5 h to dissolve a second phase in the copper alloy into the solid solution matrix as completely as possible, to obtain a solution-treated cast ingot. During the solution treatment, nitrogen is continuously passed into the heating furnace.

Performing a acid pickling process to the solution-treated cast ingot.
S3, hot rolling: under the pulse magnetic field, performing a hot rolling process on the solution-treated cast ingot with a 30-second time interval, to obtain a copper alloy slab with a thickness of 16.5 mm.

Performing a acid pickling process to the copper alloy slab.
S4, cold rolling: under the pulse magnetic field, carrying out 15 passes of cold rolling process on the copper alloy slab. Intermediate annealing treatment is applied between the cold rolling passes, with a temperature of 400° C. and a holding time of 3 hours, until the thickness is reduced to 0.203 mm, obtaining copper alloy foils.

Performing a acid pickling process to the copper alloy foils.
S5-1, magnetic field treatment: under the pulse magnetic field, performing a magnetic field treatment, followed by water cooling, the residual stress value is measured to be −122 MPa, which has transitioned from the initial compressive stress to a tensile stress state. The residual stress of the copper alloy foil samples have decreased by 15.8%.

### Embodiment 5

The difference from embodiment 4 is that S5-1 is instead by S5-2:
S5-2, tension annealing: heating and annealing the copper alloy foils at an annealing temperature of 400° C. for a holding time of 30 s, to obtain copper alloy foil samples with eliminated residual stress of −86.5 MPa. The residual stress of the copper alloy foil samples have decreased by 40%.

### Embodiment 6

The difference from embodiment 4 is that S5-1 is instead by S5-2:
S5-2, tension annealing: heating and annealing the copper alloy foils at an annealing temperature of 400° C. for a holding time of 10 min, to obtain copper alloy foil samples with eliminated residual stress of −23.1 MPa. The residual stress of the copper alloy foil samples have decreased by 84%.

### Embodiment 7

The difference from embodiment 4 is that S5 is instead by the following steps:
S5-2, tension annealing: heating and annealing the copper alloy foils at an annealing temperature of 400° C. for a holding time of 10 min.
S5-1, magnetic field treatment: under the pulse magnetic field, performing a magnetic field treatment after S5-1, the residual stress value is measured to be −20 MPa, which has transitioned from the initial compressive stress to a tensile stress state. The residual stress of the copper alloy foil samples have decreased by 86.2%.

### Embodiment 8

The difference from embodiment 4 is that S5 is instead by the following steps:
S5-1, magnetic field treatment: under the pulse magnetic field, performing a magnetic field treatment, followed by water cooling, the residual stress value is measured to be −134 MPa, which has transitioned from the initial compressive stress to a tensile stress state. The residual stress of the copper alloy foil samples have decreased by 7.5%.

### Embodiment 9

The difference from embodiment 1 is that the Cu-0.23Fe-0.06P alloy is instead by Cu-0.45Cr-0.1Zr alloy.

Parameters of the pulse magnetic field in this embodiment are as follows: voltage of 100V, peak current of 100 A, frequency of 20 Hz, and duty cycle of 20%.

A pulse magnetic field treatment method for eliminating residual stress in copper alloy thin strips is shown in FIG. 1, including the following steps:
S1, alloy casting: under the pulse magnetic field, melting the copper alloys at a temperature of 1200° C., performing a deoxidization process, to obtain alloy melt, and then injecting the alloy melt into a mold for cooling and casting to obtain an cast ingot.
S2, solution treatment: under the pulse magnetic field, heating the cast ingot at a temperature of 1000° C. and holding for 12 hours to dissolve a second phase in the copper alloy into the solid solution matrix as completely as possible, to obtain a solution-treated cast ingot. During the solution treatment, nitrogen is continuously passed into the heating furnace.

Performing a acid pickling process to the solution-treated cast ingot.
S3, hot rolling: under the pulse magnetic field, performing a hot rolling process on the solution-treated cast ingot with a 20-second time interval, to obtain a copper alloy slab with a thickness of 16.5 mm.

Performing a acid pickling process to the copper alloy slab.
S4, cold rolling: under the pulse magnetic field, carrying out 10 passes of cold rolling process on the copper alloy slab. Intermediate annealing treatment is applied between the cold rolling passes, with a temperature of 500° C. and a holding time of 2 hours, until the thickness is reduced to 0.203 mm, obtaining copper alloy foils.

Performing a acid pickling process to the copper alloy foils.
S5, magnetic field treatment and tension annealing: under the pulse magnetic field, heating and annealing the copper alloy foils at an annealing temperature of 200° C. for a holding time of 3 min. Combining heat treatment and magnetic field treatment, followed by water cooling, the residual stress value is measured to be 2.3 MPa, which has transitioned from the initial compressive stress to a tensile stress state. The residual stress of the copper alloy foil samples have decreased by 100%.

### Comparative Embodiment 1

Parameters of the pulse magnetic field in this comparative embodiment are as follows: peak current of 100 A, frequency of 20 Hz, and duty cycle of 20%.

A pulse magnetic field treatment method for eliminating residual stress in copper alloy thin strips, including the following steps:
S1, alloy casting: under the pulse magnetic field, melting the copper alloys at a temperature of 1200° C., performing a deoxidization process, to obtain alloy melt, and then injecting the alloy melt into a mold for cooling and casting to obtain an cast ingot.
S2, solution treatment: under the pulse magnetic field, heating the cast ingot at a temperature of 1000° C. and holding for 12 hours to dissolve a second phase in the copper alloy into the solid solution matrix as completely as possible, to obtain a solution-treated cast ingot. During the solution treatment, nitrogen is continuously passed into the heating furnace.

Performing a acid pickling process to the solution-treated cast ingot.
S3, hot rolling: under the pulse magnetic field, performing a hot rolling process on the solution-treated cast ingot with a 20-second time interval, to obtain a copper alloy slab with a thickness of 16.5 mm.

Performing a acid pickling process to the copper alloy slab.
S4, cold rolling: under the pulse magnetic field, carrying out 10 passes of cold rolling process on the copper alloy slab. Intermediate annealing treatment is applied between the cold rolling passes, with a temperature of 400° C. and a holding time of 10 min, until the thickness is reduced to 0.203 mm, obtaining copper alloy foils. The residual stress value is measured to be −144.9 MPa.

The comparison between the comparative embodiment 1 and the embodiment 6 shows that the residual stress of the copper alloy foils decreases after annealing treatment.

The comparison between the comparative embodiment 1 and the embodiment 1 shows that the residual stress of the copper alloy foils with both magnetic field and annealing treatment decreases by 100%, which is a significant effect.

At the same time, we have also performed tests on Cu—Cr alloys and Cu—Ni alloys, and the test results indicate that they achieve the same technical effects mentioned above.

In summary, the heat treatment process in a magnetic field can significantly reduce residual stress and improve the microstructure. The precipitation process is an atomic diffusion process, and the rate of atomic diffusion depends on the diffusion flux. The magnetic field disrupts the equilibrium vacancy concentration, increases the number of vacancies, and significantly activates their mobility, thereby accelerating the diffusion process, promoting microstructural uniformity, and ultimately reducing the residual stress within the copper alloy foil samples.

The residual stress calculation results are shown in Table 1.

TABLE 1
residual stress calculation results

| groups | residual stress (MPa) | reduction ratio (%) |
|---|---|---|
| Comparative | −144.9 | |
| embodiment 1 | | |
| Embodiment 1 | 9.8 | 100 |
| Embodiment 2 | −50 | 65 |
| Embodiment 3 | 10 | 100 |
| Embodiment 4 | −122 | 15.8 |
| Embodiment 5 | −86.5 | 40 |
| Embodiment 6 | −23.1 | 84 |
| Embodiment 7 | −20 | 86.2 |
| Embodiment 8 | −134 | 7.5 |
| Embodiment 9 | 2.3 | 100 |

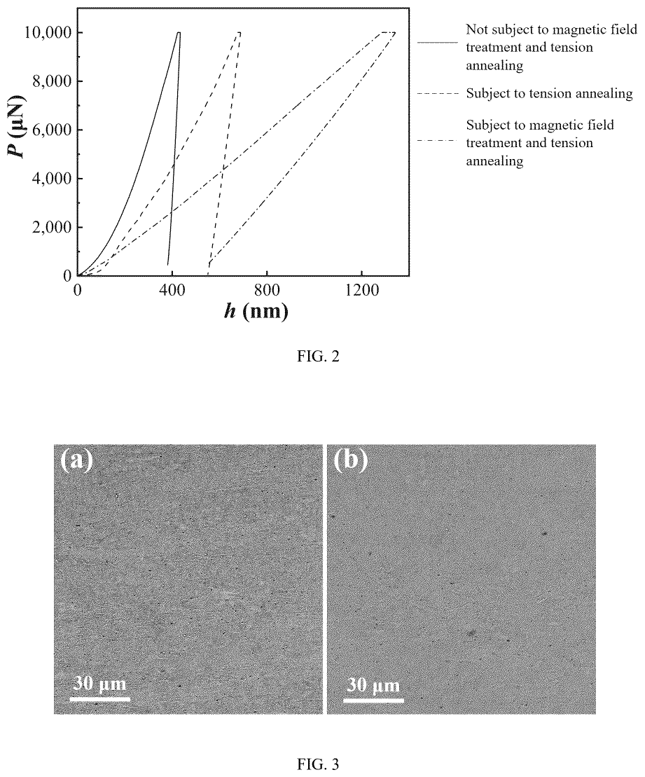

FIG. 2 is a diagram of nanoindentation loading curves of the pulse magnetic field treatment method for eliminating residual stress in the copper alloy foils according to an embodiment of the present application.

In FIG. 2, the solid line present the copper alloy foils (subject to S1-S4), the broken line represent the copper alloy foil samples treated with tension annealing (subject to S1-S4 and S5-2), the dash dot line represent the copper alloy foil samples treated with magnetic field treatment and tension annealing (subject to S1-S4, S5-1 and S5-2).

The residual stress value of the rolled sample, calculated using the nanoindentation model, is −144.9 MPa. The annealed sample, which only underwent annealing treatment on the rolled sample, has a residual stress value of −23.3 MPa. The alloy sample subjected to both magnetic field and annealing treatment, which involved annealing the rolled sample while applying a magnetic field, has a residual stress value of 9.8 MPa. This indicates that applying a magnetic field during the annealing process can reduce the residual stress.

FIG. 3 shows scanning electron microscopy images of microstructures of copper alloy foils (a) and copper alloy foil samples (b), the copper alloy foil samples (b) are subjected to both magnetic field treatment and annealing treatment. In the copper alloy foil samples (b), recrystallized microstructure appears, which is the main reason for the reduction in residual stress.

The content not detailed in the description of the present application is part of the prior art known to those skilled in the field. Although specific embodiments of the application have been described above for the convenience of understanding by those skilled in the art, it should be clear that the application is not limited to the scope of the specific embodiments. For those skilled in the art, any variations that fall within the spirit and scope of the application as defined by the appended claims are obvious, and all applications created using the concept of the present application are protected.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

1. A pulse magnetic field treatment method for eliminating residual stress in copper alloy foils, comprising the following steps:
S1, alloy casting: under a pulse magnetic field, melting copper alloys at a temperature of 1000° C. to 1300° C. to obtain alloy melt, and injecting the alloy melt into a mold for cooling and casting to obtain a cast ingot;
S2, solution treatment: under the pulse magnetic field, heating the cast ingot to a holding temperature of 800° C. to 1350° C., and holding for 0.5 h to 24 h to dissolve a second phase in the alloys completely or maximally into a solid solution matrix, to obtain a solution-treated cast ingot;
S3, hot rolling: under the pulse magnetic field, performing a hot rolling process on the solution-treated cast ingot;
S4, cold rolling: under the pulse magnetic field, carrying out N passes of cold rolling process on the copper alloy slab, where N represents a positive integer, until a desired thickness is achieved, obtaining copper alloy foils;
S5, tension annealing: under the pulse magnetic field, heating and annealing the copper alloy foils at an annealing temperature of 100° C. to 400° C. for a holding time of 30 s to 12 h, to obtain copper alloy foil samples with eliminated residual stress.

2. The pulse magnetic field treatment method for eliminating residual stress in the copper alloy foils according to claim 1, wherein specific parameters of the pulse magnetic field in S1 to S5 are as follows: a current of 20 A to 100000 A, a frequency of 20 Hz to 100 Hz, a duty cycle of 20% to 100%.

3. The pulse magnetic field treatment method for eliminating residual stress in the copper alloy foils according to claim 1, wherein, during the solution treatment in S2, an inert gas is continuously introduced to prevent oxidation of the copper alloy cast ingot.

4. The pulse magnetic field treatment method for eliminating residual stress in the copper alloy foils according to claim 1, wherein a time interval for the hot rolling process of the solution-treated ingot does not exceed 30 s.

5. The pulse magnetic field treatment method for eliminating residual stress in the copper alloy foils according to claim 1, further comprising:
performing an acid pickling process to the solution-treated cast ingot at each time of immediately prior to step S3, in between step S3 and S4, and subsequent to step S4.

6. The pulse magnetic field treatment method for eliminating residual stress in the copper alloy foils according to claim 1, wherein performing an intermediate annealing treatment during cold rolling passes of the cold rolling process in S4, to reduce the alloy hardness and facilitates further cold rolling of the copper alloy slab; wherein a intermediate annealing temperature is 100° C. to 800° C., with a holding time of 10 min to 12 h.

7. The pulse magnetic field treatment method for eliminating residual stress in the copper alloy foils according to claim 6, wherein a cold rolling pass of the intermediate annealing treatment is 10 to 30 through out the cold rolling process in S4.

8. The pulse magnetic field treatment method for eliminating residual stress in the copper alloy foils according to claim 1, wherein, the copper alloys are Cu—Fe alloys, Cu—Cr alloys, or Cu—Ni alloys.
